(19) United States
(12) Patent Application Publication
(10) Pub. No.: US 2019/0039456 A1
(43) Pub. Date: Feb. 7, 2019

(54) SPEED LIMITER SYSTEM

(71) Applicant: AUTOKONTROL LIMITED, Greater Mancheter (GB)

(72) Inventors: Andrew MAYERS, Greater Manchester (GB); Michael VALENTINE, Lancashire (GB); David ROTHERHAM, Lancashire (GB)

(21) Appl. No.: 16/076,482

(22) PCT Filed: Feb. 8, 2017
(86) PCT No.: PCT/GB2017/050303

§ 371 Date: Aug. 8, 2018

(30) Foreign Application Priority Data
Feb. 9, 2016 (GB) 1602334.3

(51) Int. Cl. B60K 31/02; B60K 31/00; F02D 41/26; F02D 41/00

(52) U.S. Cl. CPC B60K 31/02; B60K 31/00; F02D 2200/701; F02D 41/0002; B60K 2031/0091; F02D 41/26

(57) ABSTRACT

Disclosed is a vehicle speed limiter for use with a vehicle throttle system comprising a mechanically actuable throttle member, an engine speed controller, and a throttle signal unit in data communication with an engine speed controller and operably coupled to the throttle member so as to generate an electronic throttle signal in functional response to the degree of actuation of the throttle member, and to transmit a throttle signal to the engine speed controller whereby the engine speed is controlled; the vehicle speed limiter comprising a vehicle speed sensor (15) to obtain a signal indicative of vehicle speed; a GPS system (30), operable to provide a speed limit applicable for a present position of the vehicle; a comparator to compare the speed sensor (15) output with the speed limit provided from the GPS system (30); a throttle signal modifier unit (23) acting on the output of a throttle signal unit in use when fitted in conjunction with a vehicle throttle system to modify a generated throttle signal so that a transmitted throttle signal is produced such as to tend to limit the vehicle to the speed limit for the present position of the vehicle.

### FIELD

The present invention is concerned with a speed limiter system for vehicles. It particularly concerns a speed limiter system operable to regulate a vehicle's speed in accordance with a mandatory speed in limit in force for the road on which the vehicle is currently travelling.

### BACKGROUND

Automobile vehicles are widely used for personal and public transportation and for the transportation of goods. It is well established that for a variety of reasons an owner or operator of a vehicle might wish to limit the speed of the vehicle to a predetermined maximum, for example for economical or safety reasons, to comply with legislative or regulatory regimes, or for some other purpose.

Vehicle speed is usually controlled and varied by operation of a driver-operated system which acts to vary the engine speed and consequently the speed transmitted to the drive system. Such a system is commonly called a throttle system. Most commonly, the speed contract or throttle system is actuated by a foot-operated accelerator or gas pedal that can be depressed by the driver, the extent of the depression being set up to control engine speed. Manual accelerator devices such as handles are also known.

In traditional mechanically driven speed control or throttle systems, the accelerator pedal, handle or the like was mechanically coupled to a throttle valve in the fuel/air delivery system such that depression or other operation of the pedal, handle or the like opened the valve, increased the fuel/air supply, and caused an increase in engine and hence vehicle speed. From the throttling action of the valve, the term came to be used loosely for the entire engine speed control system. In such mechanical throttle systems, the speed can be limited in a number of mechanically driven ways, for example by providing a secondary means to limit the extent to which the valve can open, by disengaging the throttle pedal or handle from the valve at the desired speed etc. In particular, speed limiter systems might be fitted which acted to limit fuel or fuel/air flow into the system, for example by a suitably placed valve means fitted within a fuel supply line.

Newer vehicles increasingly operate so-called “drive-by-wire” engine speed control systems in which a direct mechanical link between the mechanical accelerator actuator and a throttle valve or other control mechanism is no longer present. Instead, an indirect electronic or electromechanical system is used, typically incorporating an electromechanical accelerator actuator unit. This electromechanical system is set up so that when a mechanically actuated throttle actuator such as an accelerator/gas pedal or handle is depressed or otherwise operated in the usual way, an electrical signal is generated which can be processed via an engine management system to control the engine speed in any suitable manner, for example by control of fuel and/or air intake or otherwise. As used herein, “throttle” is used in the broadest loose sense to refer to the actuation system to control engine speed, and does not imply only a system where the engine has a classical throttled carburetor intake, but is intended to cover any actuation system to control engine speed, in particular by controlling the fuel and/or air intake of the engine in any manner.

In electronic systems, the signal generated by the throttle actuator still varies in some functional relationship with the extent of actuation, and for example with the extent to which an accelerator pedal or handle is depressed or otherwise operated. As in fully mechanical systems, the system will be configured such that a greater extent of actuation, for example greater depression of the accelerator pedal, generates a greater signal that will tend to be interpreted by the engine management system as instructing a greater engine speed. However, there is no direct mechanical actuation link between the accelerator pedal, handle or other throttle means and a throttle valve, fuel injection system, or other control means controlling engine speed.

For the reasons set out above, a number of circumstances are still likely to arise where there might be perceived to be a need to limit the vehicle speed to a predetermined maximum. However, there is no longer a direct mechanical link within the throttle system, and purely mechanically limiting devices of the sort which have been developed for such direct mechanical throttle systems are no longer necessarily applicable.

Most drive-by-wire vehicles include complex electronic engine management systems which have as only one of their functions the receipt of an input signal from the electromechanical throttle means and the use of this signal to control engine speed. Such engine management systems might include more complex capabilities associated with a cruise control function and the setting of a cruise control speed. While such engine management systems could therefore be used, subject to modification, to set a maximum speed, they are likely to be an unnecessary complex and expensive alternative where only a simple predetermined upper limit speed is required. When a simple limit speed is desired, an option that does not necessarily require a complex engine management computer is desirable.

Difficulties can arise with fitment of a simple secondary limit device in vehicles with a complex engine management system, especially where the device is of a type that acts to limit fuel or fuel/air flow into the engine. Many conventional complex engine management systems are likely to treat such an unexpected variation in fuel flow as a fault, and may shut the engine down or revert to some safe mode of operation. Other systems may continue to operate, but in a such a manner, given the unexpected variation in fuel flow, as to risk long term damage. Thus, fitment of a secondary system that restricts or interrupts fuel supply might not be compatible with a vehicle engine management system.

As a secondary consideration, which is especially encountered for large vehicles likely to handle multiple terrain conditions, such as trucks or wagons for both road and off road (for example, quarry/mine/construction site) use is the desire to have a lower limit speed applied to the rough terrain. Again, it is desirable that a vehicle speed limiter system can provide a simple mechanism to effect a limit at either speed with a throttle system that does not have a direct mechanical link. Again, since a simple limit speed is desired, an option which does not necessarily require complex modifications to an engine management computer is desirable.

A further consideration is the desirability to control a vehicle's speed such that it does not exceed the mandated maximum speed limit for a particular section of road. This has economic advantages in ensuring better fuel consumption, safety advantages in terms of minimising the risk of accidents caused by excessive speed and advantages in terms of reducing the risk of a driver receiving a speeding ticket and/or possible driving ban.

It is an object of the present invention to provide a vehicle speed limiter system adapted for vehicles with a “drive-by-wire” engine speed control or throttle system which mitigates some or all of the above disadvantages, and which in particular does not require complex modification to or fitment of a particular engine management system.

It is a particular object of the present invention to provide a vehicle speed limiter system which can be fitted as an after market modification or design modification to existing vehicles with “drive-by-wire” throttle systems, without requiring extensive modification to or fitment of complex engine management systems. Thus, in accordance with the invention in its broadest aspect, a vehicle speed limiter is provided suitable for use with a vehicle throttle system comprising a mechanically actuatable throttle member, an engine speed controller, and a throttle signal unit in data communication with an engine speed controller and operably coupled to the throttle member so as to generate an electronic throttle signal in functional response to the degree of actuation of the throttle member, and to transmit a throttle signal to the engine speed controller whereby the engine speed is controlled.

It is a further object of the present invention to allow the vehicle to be controlled such that a speed limit for a particular road or stretch of road may not be exceeded.

### SUMMARY

The system is thus a “drive-by-wire” throttle system, in which an electromechanical throttle unit sends a signal electronically to an engine speed controller and thus effects control of engine speed in any suitable manner, for example by controlling fuel and/or air input to the engine and for example controlling fuel injection rates.

According to an aspect of the present invention, there is provided a vehicle speed limiter for use with a vehicle throttle system comprising a mechanically actuable throttle member, an engine speed controller, and a throttle signal unit in data communication with an engine speed controller and operably coupled to the throttle member so as to generate an electronic throttle signal in functional response to the degree of actuation of the throttle member, and to transmit a throttle signal to the engine speed controller whereby the engine speed is controlled; the vehicle speed limiter comprising a vehicle speed sensor to obtain a signal indicative of vehicle speed; a GPS system, operable to provide a speed limit applicable for a present position of the vehicle; a comparator to compare the speed sensor output with the speed limit provided from the GPS system; a throttle signal modifier unit acting on the output of a throttle signal unit in use when fitted in conjunction with a vehicle throttle system to modify a generated throttle signal so that a transmitted throttle signal is produced such as to tend to limit the vehicle to the speed limit for the present position of the vehicle.

In one embodiment, the throttle signal modifier unit is adapted for attachment in use in data communication between the throttle signal unit and the engine speed control unit in that it includes an input in data communication with the throttle signal unit to receive an input signal comprising an unmodified throttle signal from the throttle signal unit and an output in data communication with the engine speed control unit to output a throttle signal thereto.

In one embodiment, the speed sensor is adapted to make use of an existing vehicle system allowing for the sensing of speed.

In one embodiment, the speed sensor is adapted for fitment to the vehicle speedometer system to obtain a reading of speed therefrom.

In one embodiment, the vehicle speed limiter is adapted for use with a throttle signal unit including an electronic signal generator configured such that a varying electronic signal is in inherently produced as the throttle member is operated to a varying extent in that the signal modifier unit is able to modify the generated electronic signal in that it is electrically connected to the electronic signal generator so as to be able to pull the generated voltage lower than it would otherwise be set to by the operation of the throttle member without operation of the speed limiter.

In one embodiment, the vehicle speed limiter is adapted to operate continuous successive cycles of speed sensing and throttle signal modification as necessary.

In one embodiment, the vehicle speed limiter is adapted to include speed limit control means adapted to effect such successive monitoring, and further adapted to apply the proportional control technique whereby, as the comparator detects that the set speed is approached to a certain predetermined degree of closeness, the signal modifier begins to apply a signal modification which becomes stronger the near the vehicle comes to the set speed.

In one embodiment, the GPS system is operable to discern the present position of the vehicle and to cross-refer the present position with a database including information regarding a prevailing speed limit associated with the present position.

In one embodiment, the vehicle is further provided with a default maximum speed and in the event that the default maximum speed is lower than the speed limit, the vehicle is limited to the default maximum speed.

In one embodiment, a vehicle is provided with a vehicle speed limiter in accordance with an aspect of the invention.

Advantageously, an embodiment of the present invention allows a vehicle speed limiter to operate in a manner which prevents an associated vehicle from exceeding a defined speed limit for a specific road, as determined by the position of the vehicle.

A further default maximum speed limit is provided such that if the GPS system is inoperable for any reason, or if the vehicle in question is not permitted to travel at the speed limit for a particular road, then the vehicle is limited to that default maximum speed instead.

It is important to realise that the speed limiter according to an embodiment of the present invention differs from a cruise-control, fitted to many vehicles now. Throughout this specification, speed limiter is to be interpreted as a system which may not be over-ruled by a driver and is provided to enhance vehicle safety and/or fuel efficiency. A cruise control system is provided for driver-convenience only and may be over-ruled at will. The two systems are entirely distinct and serve different purposes.

### BRIEF DESCRIPTION OF DRAWINGS

For a better understanding of the invention, and to show how embodiments of the same may be carried into effect, reference will now be made, by way of example, to the accompanying diagrammatic drawings in which:

FIG. 1 shows a schematic representation of a system according to an embodiment of the present invention.

### DESCRIPTION OF EMBODIMENTS

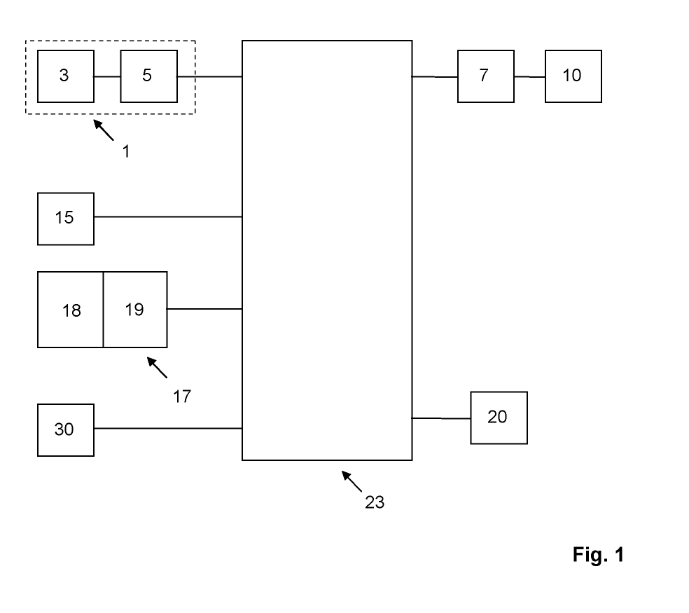

As shown in FIG. 1, the system is a “drive-by-wire” type system in which an electromechanical throttle (1) controls the speed of an engine (5) (and hence a vehicle) via an electronic signal transmitted through and processed by an engine management system controller (7) which includes at least an engine speed controller.

Ultimate user control is effected by actuation of a mechanical throttle actuator (3), which in this typical example comprises an accelerator/gas foot pedal mounted within a vehicle cabin to be accessible by and operable by the driver. The mechanical actuator (3) is mounted in conjunction with a throttle signal generation means (5) which generates an electronic throttle signal corresponding to the extent to which the mechanical actuator is operated. In the present example, depression of the accelerator pedal operates in conjunction with a pair of potentiometers to generate a functionally related electronic throttle signal corresponding to the extent to which the pedal is depressed.

The resultant electronic throttle signal is passed to a throttle signal modifier unit (23) and then transmitted to an engine management system computer (7) which includes at least an engine speed controller.

Where the speed limiter is not activated i.e. it is not acting to limit the vehicle speed, then the signal output from the throttle signal modifier unit (23) is identical to the signal input to the unit (23) and is processed by the engine speed controller and used to control the speed of the engine (10) as if the unit (23) were not present. In other words, at all speed below the current maximum speed, the unit (23) essentially passes the throttle signal generated by the throttle (1) unaltered.

A pair of potentiometers is used in the example (not shown) in the signal generation system (5) to give a degree of redundancy for safety. A pair of throttle signals is thereby generated, each signal being transmitted to and processed separately by the engine management system. In the event that the signals essentially correspond, within a pre-set safety margin, that is taken as the intended throttle signal, and the system operates accordingly. In the event that there is an excessive differential between the signals in the pair, which is likely to arise for example if there is a fault with one of the potentiometers or its corresponding data link, the engine management system will be designed to detect this as a fault. It might then refuse to operate the throttle system, or to operate the throttle system only in a safe mode (for example applying a predetermined limit), until the fault can be rectified.

To the above extent, the throttle is essentially a conventional drive-by-wire throttle system. However, the schematic example illustrates such a throttle system modified, either by prior manufacturer's design or as an after market fitment, with a speed limiter system in accordance with the invention.

The speed limiter system first includes a speed sensor (15). Again, for practical purposes, this is likely to make use of an existing speed sensor within the vehicle, for example provided within the transmission system or braking system, although a specific additional speed sensor could alternatively be provided. The speed sensor will normally be such as to sense, directly or indirectly, the vehicle speed, since it is this that it is ultimately the intention of the system of the invention to limit. For example the speed sensor (15) is fitted to and takes a signal from a vehicle speedometer and thus senses vehicle speed indirectly by taking a direct reading of the rotational speed/frequency of the transmission shaft.

Additional sensors may be provided for example to limit engine speed (for example to set a maximum engine revolutions rate) and the skilled person would readily appreciate that these additional sensors could similarly be incorporated into a limiter system of the invention with minimal trivial further modification. However, they are not directly pertinent to the present invention, which is primarily a means to limit vehicle speed to a limit applicable to the particular road on which the vehicle is travelling.

In order to acquire the speed limit applicable to the road on which the vehicle is currently travelling, the speed limiter system is provided with a GPS system (30), which feeds data to the throttle signal modifier unit (23). The GPS system (30) is operable to determine the vehicle's current position and trajectory in a known way. This position information is cross-references with a database provided in the GPS system (30) which gives maximum speed (or speed limit) data for that particular stretch of road. Such data is freely available and is update periodically by either state or commercial entities.

For instance, a vehicle may be travelling on a relatively ‘fast’ road, such as dual carriageway in the United Kingdom, an Autobahn in Germany or a freeway in the United States and the maximum speed may be e.g. 60 Miles Per Hour (or 100 km per hour). By knowing the vehicle location, the GPS system is able to provide to the throttle signal modifier unit (23) a data signal corresponding to the said speed limit for that road. The throttle signal modifier unit (23) then acts to limit the vehicle speed to that maximum, such that even by increasing pressure on the throttle (1), the vehicle will not travel faster than the maximum speed.

As the vehicle moves from one maximum speed area to another, the throttle speed modifier unit (23) acts to alter the throttle signal which is passed to the engine management system computer (7) so that the vehicle may not exceed the speed limit at all times, regardless of the user's operation of the throttle.

As a safety backup system and to take account of situations where a given vehicle's maximum speed may be set to be less than the maximum allowed on a particular road, the system is provided with a data store (17) which includes a fixed and unalterable (for a given vehicle) maximum speed setting. If the maximum speed on a motorway, for instance, is 70 Miles per hour, but a heavy goods vehicle may not exceed 60 Miles per hour, then the throttle signal modifier unit is operable to limit the vehicle to the lower of the two speeds provided by the data store (17) and the GPS system (30).

In the event that the GPS system is faulty or the requisite satellites are not visible, such that the vehicle's position cannot be determined, then the throttle signal modifier unit (23) acts to limit the vehicle to the maximum speed indicated by the value stored in the data store (17).

A maximum speed is set in the data store (17). The data store (17) in this embodiment includes at least a first data register (18) including a default maximum speed for the vehicle as referred to above. This is the maximum speed which the vehicle may travel at, regardless of the speed limit information provided by the GPS system (30). The second data register (19) provided in data store (17) is provided to the maximum speed which the vehicle may assume over rough terrain.

In the embodiment shown, two predefined limit speeds are stored, which may be applicable in certain conditions. However, in most circumstances, the vehicle's speed is limited to that provided in information from GPS system (30).

However, when the limits stored in registers (18) and (19) are active and applied to the vehicle, selection between them is effected automatically in the manner below described using a vibration sensor. This is an illustrative example only. A data register may provide for the storage of a single limit speed only. Multiple limit speeds may be stored for other reasons. If multiple limit speeds are stored, selection between may be made in other ways either automatically in accordance with some predetermined or sensed condition or by a user selection action.

In the illustrated embodiment, selection of the vehicle speed limit is carried out as follows. In normal driving conditions (i.e not rough terrain), then the vehicle is limited to the speed indicated in the data provided from GPS system (30) for the particular road or stretch of road on which the vehicle is currently travelling, unless the speed limit for the particular road is higher than the default maximum speed stored in register (18), in which case the vehicle is limited to the default maximum speed.

If rough terrain is detected (as described below), then the vehicle is limited to the maximum speed stored in register (19) applicable for rough terrain, regardless of either the maximum speed stored in register (18) or the speed limit information provided from GPS system (30).

The decision as to whether the vehicle is driving on rough terrain is determined by a vibration monitor system which is intended to be of a sensitivity such as to detect whether the vehicle is on or off road. The vibration monitor system (20) includes a vibration sensor such as a trembler switch, and suitable electronic control means which determine conditions under which the switch is considered to be tripped, as a result of which a different limit is selectively to be applied. The vibration monitor system (20) reads the limits from the data register (19), determines that the vehicle should be limited to the speed there indicated and the throttle modifier unit (23) acts to limit the vehicle to that speed. Thus, where such vibration conditions as are necessary to register with the trembler switch control means are complied with, an appropriate lower speed limit is passed from the register (19). It is of course possible, without departing from the principles of the present invention, to have a vibration system sensitive to several discrete degrees of vibration, and to apply several different limit speeds correspondingly.

The purpose of these varied limits is to set a different maximum speed for road and off-road conditions. A number of vehicles, in particular large, heavy vehicles such as trucks, are specifically designed for heavy operation both on and off road. Maximum speeds which might be set by a regulatory regime or otherwise as suitable for paved roads, are entirely inappropriate for use off such a road, for example on a roughly made site road. The system of the invention applies a different maximum speed dependent upon the roughness of terrain.

Furthermore, an off road position may be implied from the location of the vehicle if there is no speed limit data available for that position. In this way, regardless of any reading from the vibration monitor system (20), the absence of any speed limit data, die to the vehicle not being on a recognised road may be used to trigger a lower vehicle speed, as stored in register (19).

In order to describe the operation of the throttle signal modifier unit, it will be assumed that the vehicle is to be set not to exceed the speed indicated in data received from the GPS system (30). As previously mentioned, this speed may be altered or over-ridden in circumstances where the default maximum speed is lower or the vehicle is on rough terrain.

In the event that the vehicle is travelling in a 30 MPH zone and the driver is attempting to travel at a greater speed b increasing the pressure on the throttle, then the throttle signal modifier unit acts to maintain a vehicle speed of 30 MPH by not allowing the throttle signal passed to the engine management system (7) to increase. In this way, the vehicle is not allowed to exceed a speed of 30 MPH. At all times, speed limit data applicable to the vehicle's current position is provided from GPS system (30).

As the vehicle moves onto a faster road, where the limit is 60 MPH, then the user's increased pressure on the throttle is recognised by the throttle signal modifier unit (23) and the increased voltage is allowed to pass to the engine management system (7), increasing the vehicle's speed, until the sensed vehicle speed approaches the speed limit indicated by GPS system (30). As the sensed speed approaches the maximum speed, then the throttle signal modifier unit acts to slow the rate of voltage increase such that the vehicle approaches the maximum speed in a controlled manner and avoids speed overshoot. The manner in which the voltage is controlled in this way may differ slightly from vehicle to vehicle (for instance a heavy goods vehicle would need a different control profile to a light automobile).

In an alternative embodiment, the signal produced by the throttle (1) is a digital signal, rather than an analogue signal as described previously. In a particular embodiment, the signal comprises a train of pulses, wherein the instantaneous pulse width is indicative of the extent to which the pedal is depressed. As the pedal is depressed further, the pulse width decreases (or the gap between the pulses increases). Of course, the system can be designed so that as the pedal pressure is increased, the pulse width increases. The skilled person will readily appreciate that as long as the system operates consistently, it is not relevant whether the pulse width increases or decreases with increasing pedal pressure.

The engine speed management system (7) is therefore “fooled” into receiving a signal which corresponds to an apparent level of throttle actuation that tends to limit the speed to, and bring the vehicle speed within, the limit speed. In the specific example, where the throttle signal is generated by a pair of potentiometers, the throttle signal modifier unit (23) acts to draw off some of the potential generated by the potentiometers and thus cause the apparent signal received by the engine management system (7) to appear to correspond to a depression of the accelerator which would limit the engine speed, and hence vehicle speed, to the desired limit.

In the case of a digital throttle signal as set out above, the skilled person will realise that other encoding schemes may be used. As long as the throttle signal modifier unit (23) is operable to mimic a signal of a given speed, depending on the inputs it receives, then it is able to pass an appropriate signal to the engine management system (7).

In the case where the vehicle is moving from a higher current speed to a lower maximum speed limit, for instance from a 60 MPH to a 30 MPH zone, then the throttle signal modifier unit (23) acts to reduce the throttle voltage in a controlled manner until the sensed speed approaches the limit speed and then settles at the lower speed indicated from the GPS system (30).

It will be readily understood that throttle signal modifier unit (23) can work in a number of ways without departing from the general principles of the invention. At it simplest, it merely compares the measured speed with the limit speed, and acts modify the throttle signal only if the sensed speed exceeds the limit speed.

However, it will be generally be preferred, and in the present example it is assumed, that the throttle modifier unit (23) operates a more sophisticated algorithm whereby, as the sensed speed tends to approach the limit speed from below, the throttle signal modifier is caused progressively to apply to seek to limit the effect of actuation of the throttle more progressively, and thus to seek to limit the vehicle speed at or below the applicable limit in a more smooth and controlled manner.

Thus, the system of the invention offers a solution to the problem of limiting speeds in drive-by-wire throttle systems, which requires no complex modification to any existing engine management system, and is therefore admirably suited to incorporation into existing designs either as a pre- or after market fitment thereto.

Attention is directed to all papers and documents which are filed concurrently with or previous to this specification in connection with this application and which are open to public inspection with this specification, and the contents of all such papers and documents are incorporated herein by reference.

All of the features disclosed in this specification (including any accompanying claims, abstract and drawings), and/or all of the steps of any method or process so disclosed, may be combined in any combination, except combinations where at least some of such features and/or steps are mutually exclusive.

Each feature disclosed in this specification (including any accompanying claims, abstract and drawings) may be replaced by alternative features serving the same, equivalent or similar purpose, unless expressly stated otherwise. Thus, unless expressly stated otherwise, each feature disclosed is one example only of a generic series of equivalent or similar features.

The invention is not restricted to the details of the foregoing embodiment(s). The invention extends to any novel one, or any novel combination, of the features disclosed in this specification (including any accompanying claims, abstract and drawings), or to any novel one, or any novel combination, of the steps of any method or process so disclosed.

1. A vehicle speed limiter for use with a vehicle throttle system comprising a mechanically actuable throttle member, an engine speed controller, and a throttle signal unit in data communication with an engine speed controller and operably coupled to the throttle member so as to generate an electronic throttle signal in functional response to the degree of actuation of the throttle member, and to transmit a throttle signal to the engine speed controller whereby the engine speed is controlled; the vehicle speed limiter comprising a vehicle speed sensor to obtain a signal indicative of vehicle speed; a GPS system, operable to provide a speed limit applicable for a present position of the vehicle; a comparator to compare the speed sensor output with the speed limit provided from the GPS system; a throttle signal modifier unit acting on the output of a throttle signal unit in use when fitted in conjunction with a vehicle throttle system to modify a generated throttle signal so that a transmitted throttle signal is produced such as to tend to limit the vehicle to the speed limit for the present position of the vehicle.

2. A vehicle speed limiter in accordance with claim 1 wherein the throttle signal modifier unit is adapted for attachment in use in data communication between the throttle signal unit and the engine speed control unit in that it includes an input in data communication with the throttle signal unit to receive an input signal comprising an unmodified throttle signal from the throttle signal unit and an output in data communication with the engine speed control unit to output a throttle signal thereto.

3. A vehicle speed limiter in accordance with claim 1 the speed sensor is adapted to make use of an existing vehicle system allowing for the sensing of speed.

4. A vehicle speed limiter in accordance with claim 3 wherein the speed sensor is adapted for fitment to the vehicle speedometer system to obtain a reading of speed therefrom.

5. A vehicle speed limiter in accordance with claim 1 adapted for use with a throttle signal unit including an electronic signal generator configured such that a varying electronic signal is in inherently produced as the throttle member is operated to a varying extent in that the signal modifier unit is able to modify the generated electronic signal in that it is electrically connected to the electronic signal generator so as to be able to pull the generated voltage lower than it would otherwise be set to by the operation of the throttle member without operation of the speed limiter.

6. A vehicle speed limiter in accordance with claim 1 adapted to operate continuous successive cycles of speed sensing and throttle signal modification as necessary.

7. A vehicle speed limiter in accordance with claim 6 including speed limit control means adapted to effect such successive monitoring, and further adapted to apply the proportional control technique whereby, as the comparator detects that the set speed is approached to a certain predetermined degree of closeness, the signal modifier begins to apply a signal modification which becomes stronger the near the vehicle comes to the set speed.

8. A vehicle speed limiter in accordance with claim 1 wherein the GPS system is operable to discern the present position of the vehicle and to cross-refer the present position with a database including information regarding a prevailing speed limit associated with the present position.

9. A vehicle speed limiter in accordance with claim 1 wherein the vehicle is further provided with a default maximum speed and in the event that the default maximum speed is lower than the speed limit, the vehicle is limited to the default maximum speed.

10. A vehicle provided with a vehicle speed limiter in accordance with claim 1.
